(19) United States
(12) Patent Application Publication
(10) Pub. No.: US 2011/0190438 A1
(43) Pub. Date: Aug. 4, 2011

(54) METHOD OF IMPROVING THE COLD FLOW PROPERTIES OF A PARAFFIN-CONTAINING FLUID

(75) Inventors: Raquel Rodriguez Gonzalez, Stavanger (NO); Jostein Djuve, Stavanger (NO); Anders Grinrod, Stavanger (NO)

(73) Assignee: SCHLUMBERGER NORGE AS, Tananger (NO)

(21) Appl. No.: 13/002,954

(22) PCT Filed: Jul. 3, 2009
(86) PCT No.: PCT/EP2009/058394

§ 371 Date: Apr. 11, 2011

Related U.S. Application Data
(60) Provisional application No. 61/079,677, filed on Jul. 10, 2008.

(51) Int. Cl. C08L 39/06; C08L 33/08; C08K 5/01

(52) U.S. Cl. 524/516; 524/548

(57) ABSTRACT

A method of improving the cold flow properties of a paraffin-containing fluid that includes admixing an effective amount of a polymer comprising cyclic amide and long chain alkyl functionality is disclosed.

### BACKGROUND OF INVENTION

1. Field of the Invention

Embodiments disclosed herein relate generally to methods of improving the cold flow properties of a paraffin-containing fluid. In particular, embodiments disclosed herein relate to additives capable of lowering the pour point of a paraffin-containing fluid.

2. Background Art

In the hydrocarbon drilling and production industry, crude oil refers to the desirable (and undesirable) hydrocarbon products extracted from the ground together with the associated aqueous phase and minor amounts of solids. The proportion of hydrocarbons in crudes varies from 5% to almost 100%, and comprises thousands of different molecules that may be grouped into four families of compounds: saturates, aromatics, resins and asphaltenes. Saturates generally constitute the lightest fraction of the crude oil while within the saturates family, C₁₈₊ long-chain linear paraffins represent the heavy fraction of the saturates and are responsible for wax deposit formation.

Paraffin is a common name for a group of alkane hydrocarbons with the general formula CₙH₂ₙ₊₂, where n is the number of carbon atoms. Paraffins may be divided into three groups: gases at room temperature (the lowest carbon number alkanes, C₁-C₄), liquids at room temperature (intermediate carbon number alkanes, C₅-C₁₇), and solids at room temperature (paraffin wax) (the heaviest alkanes, C₁₈ and above). At low temperatures (or at temperatures below the melting point for respective alkanes), long-chained compounds are known to crystallize and form large wax crystals having a sponge-like structure. Other constituents of the paraffin-containing fluid may also be trapped in the crystals' structures, which may lead to a faster growth of the wax network. The wax crystals may agglomerate or mass together, which may finally lead to the deposition of the paraffins on the transportation equipment and to the clogging of such equipment. Furthermore, the formation of a solid wax phase may lead to an increased viscosity, which means that the paraffin-containing fluid may become significantly more difficult to handle.

Paraffin deposition is a well-known phenomenon that plagues the oil industry all over the world. Typically, various types of products derived from crude oils such as diesel fuels, various oils of lubricating viscosity, automatic transmission fluids, hydraulic oil, home heating oils, crude oils and natural gas liquids and fractions thereof contain several types of hydrocarbons, such as paraffins.

At the temperature of the reservoir, the paraffins may be primarily liquid or gaseous and thus are dissolved in the crude oil. As the production stream rises to the surface and leaves the wellhead, the temperature and pressure start to decrease; the stream begins to cool from the elevated temperature and pressure as compared to the temperature and pressure of the wellhead. This chilling results in loss of fluidity and deposition of waxes, asphaltenes, etc., which drastically affects production operations. The wax deposits formed consists mainly of n-paraffins (linear alkanes) and small amounts of branched or isoparaffins and aromatic compounds (cycloparaffins, naphthalenes). The carbon number of paraffinic molecules present in wax deposits is typically C₁₅ or higher and may reach up to C₈₀. Studies have also indicated that the quantity of wax formation that will prevent flow or gel for an oil is quite small.

Remediation of wax deposition has conventionally been solved in onshore fields with various inexpensive physical and chemical methods. However, as the oil industry is continually moving to deep water scenarios where paraffin deposition takes place in difficult-to-reach subsea flow lines, manifolds, wet Xmas trees, etc., other solutions need to be found for paraffin deposition problems in deepwater production facilities for current solutions are costly, time-consuming and thus pose a serious menace to the economical feasibility of their enterprises.

Dewaxing of an oil, the process of removing hydrocarbons which solidify readily (waxes) from petroleum fractions, may improve the low temperature fluidity of paraffin-containing fluids. This process may be accomplished using many different means, however, it is often considered to be an expensive procedure. Such dewaxing techniques have been used in combination with additives that reduce the size and change the shape of the wax crystals that form. Such additives operate on the basis that smaller size crystals are desirable as they are less likely to clog a filter. Other traditional methods to remediate wax crystallization are based on removing the precipitates already formed by thermal or mechanical methods, or by means of solvents.

Accordingly, there exists a continuing need for developments in the prevention or inhibition of wax formation, thereby improving flow properties of fluids having paraffins contained therein, rather than remediative techniques conventionally used.

### SUMMARY OF INVENTION

In one aspect, embodiments disclosed herein relate to a method of improving the cold flow properties of a paraffin-containing fluid that includes admixing an effective amount of a polymer comprising cyclic amide and long chain alkyl functionality.

In another aspect, embodiments disclosed herein relate to a method of improving the cold flow properties of a paraffin-containing fluid that includes admixing with the fluid a copolymer formed from vinylpyrrolidone and a C₁₂₊ alpha-olefin.

Other aspects and advantages of the invention will be apparent from the following description and the appended claims.

### BRIEF DESCRIPTION OF DRAWINGS

FIG. 1 is a graph showing the n-paraffin carbon number distribution for three synthetic oils that were experimentally treated with the pour point depressants according to the present disclosure.

FIG. 2 is a graph showing the viscosity data of non-treated Oil 1 and of Oil 1 treated with the pour point depressants according to the present disclosure.

FIG. 3 is a graph showing the viscosity data of non-treated Oil 2 and of Oil 2 treated with the pour point depressants according to the present disclosure.

FIG. 4 is a graph showing the n-paraffin carbon number distribution for seven natural crude oils that were experimentally treated with the pour points depressants according to the present disclosure.

FIG. 5 is a graph showing the viscosity data of non-treated and treated Sudan (Palouge) crude oil.

FIG. 6 is a graph showing the viscosity data of non-treated and treated Sudan (Adar) crude oil.

FIG. 7 is a graph showing the viscosity data of non-treated and treated Vietnam crude oil.

FIG. 8 is a graph showing the viscosity data of non-treated and treated Croatia crude oil.

FIG. 9 is a graph showing the viscosity data of non-treated and treated Malaysia crude oil.

### DETAILED DESCRIPTION

Embodiments disclosed herein are directed to methods of improving the cold flow properties of paraffin-containing fluids, such as by preventing paraffin wax formation. In particular, embodiments disclosed herein are directed to methods comprising admixing at least one copolymer of vinylpyrrolidone and alpha-olefin with such paraffin-containing fluid.

Prevention of paraffin wax formation may be achieved in accordance with embodiments of the present disclosure by depressing the pour point of paraffin-containing fluids to inhibit wax crystallization. The pour point of a fluid may be defined as the temperature at which the fluid sample is no longer considered to flow when subjected to the standardized schedule of quiescent cooling prescribed by ASTM D97-47 or ASTM D5853.

The fluids to which the present disclosure may be applicable comprise paraffin-containing fluids such as wax-containing oils and natural gas liquids, and for example crude oil, shale oil, petroleum, tar sands oil, and mixture thereof. However the copolymers of the present disclosure may be suitable for reducing the pour point of paraffin-containing fluids containing high molecular weight linear paraffins, i.e., paraffins having at least 20 carbon atoms. Further, the copolymers may be particularly suitable for treating fluids containing high molecular weight linear paraffins with at least 25 carbon atoms.

Pour point depressants (PPDs), also called flow improvers, wax crystal modifiers or paraffin inhibitors, physically interact with the paraffin chains of the precipitating paraffin crystals. The consequence is that the pour point of the paraffin-containing fluid decreases and the fluidity of said fluid is maintained across a wider temperature range.

The mechanism of action by which PPDs operate has been the subject of much interest. PPDs do not make the wax more soluble in oil; rather, they function by disrupting or preventing the formation of the waxy network. They are designed to interfere in the wax crystallization process, thus modifying the crystal structure. Early studies postulated PPDs function by coating the surface of the wax crystals to prevent further growth; however more recent studies have suggested that the PPDs may either be absorbed into the face of the wax crystal or co-crystallize with the wax crystal. Thus, crystal growth is not prohibited; it is simply directed or channeled along different routes. Light microscopy suggests that wax crystals are typically thin plates or blades, and when a PPD is added to the system, those crystals are smaller and more branched, and thus the PPD may disrupt or redirect crystal growth from different directions into a single direction and bulkier crystals will be formed. Thus, with an effective PPD, wax crystals then may form networks only at much lower temperatures which results in a lower pour point for the liquid in which paraffins are contained.

In accordance with embodiments of the present disclosure, PPDs may be structured so that part of the molecule contains a long-chain alkyl group soluble in the paraffin-containing fluid (paraffin-like part), while the other part of the structure contains a polar dispersant group (polar part). The paraffin-like part may provide nucleation sites and may co-crystallize with the paraffins in the paraffin-containing fluid, while the polar part may incorporate on the surface of the paraffin crystals thus inhibiting the extensive crystal growth by reducing the size of the paraffin crystals.

When designing or selecting compounds suitable to act as pour point depressants, the following traits or characteristics may be considered: low-temperature performance at low concentrations in a wide variety of paraffin-containing fluids, ability to lower the pour point, viscosity and yield stress of paraffin-containing fluids, whether the alkyl chain length of the pendant groups matches with the average carbon number of the paraffins in the paraffin-containing fluid, a cloud point close to the paraffin-containing fluid wax appearance temperature (WAT), a melting point close to the paraffins in the paraffin-containing fluid, cost competitiveness (as compared to other commercially available products), ease in synthesis and handling, thermal, oxidative and chemical stability, have low intrinsic pour point, flash, viscosity and yield stress, be crystalline and soluble in paraffin-containing fluids, and have weak polarity rather than non-polarity or high polarity.

The copolymers used in the present disclosure as Pour Point Depressants (PPDs) may include copolymers having cyclic amides as well as long-chain alkyl functionality. The cyclic amide functionality may be achieved from a cyclic amide monomer, which may be reacted with at least one other monomer to form the copolymer. Exemplary cyclic amides, also referred to as lactams, that may be used as monomers in forming the copolymer may include vinylpyrrolidone (CH₂═CH—C₄H₆NO), a five-membered lactam ring, vinylcaprolactam (CH₂═CH—C₆H₁₀NO), a seven membered lactam ring, etc.

In some embodiments, the long-chain alkyl functionality may be achieved by reacting a cyclic amide with alpha-olefin monomers. Alpha-olefins (or α-olefins) are a family of organic compounds which are alkenes with a chemical formula CₓH₂ₓ, distinguished by having a double bond at the primary or alpha (α) position (CH₂═Cₓ₋₁H₂₍ₓ₋₁₎). There are two types of alpha-olefins, branched and linear (or normal). The chemical properties of branched alpha-olefins with a branch at either the second or the third carbon are significantly different from the properties of linear alpha-olefins and those with branches on the fourth carbon number and further from the start of the chain. In particular embodiments of the present disclosure, the alpha-olefin of at least one copolymer is a linear alpha-olefin. Alpha-olefins suitable for reaction with the cyclic amide include any C₂-C₄₀ hydrocarbon having an α-β double bond.

Alternatively, the long-chain alkyl units may be formed by use of an α-β unsaturated monomer which may be subsequently modified to have a long alkyl chain added thereon. For example, such monomers may include vinyl acrylates, maleic anhydride, and 1,2-ethylenedicarboximide, etc. Acrylates easily form polymers because the double bonds are very reactive. Upon reaction of an acrylate with a cyclic amide, the resulting polymer may be transesterfied with a long chain aliphatic alcohol. Further, one skilled in the art would appreciate that similar types of reactions may occur with maleic anhydride or 1H-pyrrole-2,5-dione (also called maleimide) to achieve the long chain alkyl functionality. Furthermore, it is also within the scope of the present disclosure that alkyl, alkenyl, aryl or arylalkyl groups may be added to the active sites in the moieties of the N-heterocyclic structural unit (i.e., the vinylpyrrolidone monomer) after the copolymerization reaction. In such an embodiment, the cyclic amide may be reacted with any of the monomers described herein, as well as short-chain alpha-olefins

For an optimum interaction between the PPDs and the paraffins in the fluid, the pendant chains of the PPDs according to the present disclosure may match with the paraffin distribution in the fluid. In particular embodiments of the present disclosure, the long alkyl chain functionality may comprise at least 12 carbon atoms up to 40 carbon atoms. In other embodiments, the long alkyl chain functionality may comprise 16 to 30 carbon atoms. In yet another embodiment, the long alkyl chain functionality may comprise 30 carbon atoms. When alpha-olefins are reacted with a cyclic amide, any alpha olefin having a molecular weight from about 28 to as high as 2500 may be employed as the co-monomer, as well as in the alkylation of the active site in the moieties of the N-heterocyclic monomer. Mixtures of suitable alpha olefins may also be used. While linear alpha olefins are preferred because of their interaction properties with the linear paraffins in the fluid, isomers of alpha olefins ranging from 1-dodecene to 1-tetracontene as well as polyalkenes may also be employed in the polymerization reaction. When such isomers are used, ethylenic unsaturation in the alpha position may allow for greater reactivity.

In forming the copolymers from the respective monomers, the copolymers may comprise from 20 to 90 wt % of vinylpyrrolidone (or other N-heterocycle) and 10 to 80 wt % of the alpha-olefin, acrylate, maleic anhydride, or dicarboximide monomer in some embodiments, and from 20 to 50 wt % of vinylpyrrolidone and 50 to 80 wt % of the alpha-olefin, acrylate, maleic anhydride, or dicarboximide monomer in other embodiments. In a particular embodiment, the copolymers may comprise about 20 wt % of vinylpyrrolidone and about 80 wt % of an alpha-olefin monomer.

Further, preferred copolymers may be vinylpyrrolidone—alpha-olefin copolymers having a weight average molecular weight of at least 3.000 in some embodiments of the present disclosure, and from 10.000 to 250.000 in others, the preferable molecular weight range being between 10.000 to 50.000.

The amount of PPDs used in treating a crude oil will vary according to various factors such as the base fluid type, the paraffin content in the fluid, the n-paraffin carbon number distribution for the fluid, the type of polymers, the degree of pour point and viscosity corrections desired, the ambient conditions, etc. The optimum dose rate is normally estimated by means of laboratory measurements such as pour point, viscosity, gel strength, wax deposition tendency, etc. Therefore, there are no limitations in this regard. Thus, the copolymers may be added in effective amount, i.e., an amount sufficient to produce some reduction in pour point of a paraffin-containing fluid. Generally, however, each copolymer may be added in a concentration of at least 50 ppm in some embodiments, and in a concentration of from 50 and 5000 ppm in other embodiments. In some other embodiments, the concentration varies from 250 to 1000 ppm. Further, one skilled in the art would appreciate that ranges may depend on the types of oil being treated, and that the desirable amount is an amount sufficient to achieve the highest variance in pour point and viscosity at the lowest dosage possible.

In some embodiments, the addition of the copolymers according to the present disclosure to a paraffin-containing fluid leads to a lowering of the pour point of the fluid by at least 3° C. In other embodiments, the pour point variation is at least 10° C. and, in yet other embodiments, the pour point variation is at least 50° C. One skilled in the art would appreciate that any depressant effect may be desirable, particularly in the treatment of heavy oils with high content of C₁₈₊ n-paraffins.

The copolymers of the present disclosure may be prepared by any of the methods known by one with skill in the art and typically by free-radical polymerization. Polymerization can take place under a variety of conditions, including bulk polymerization, solution polymerization, usually in an organic solvent common to the monomers, emulsion polymerization, suspension polymerization and non-aqueous dispersion techniques. A suitable preparation process comprises dissolving the monomers in an organic solvent and carrying out the polymerization in the presence of a free radical initiator at a temperature ranging from 30 to 200° C. Suitable solvents may include various alcohols (e.g. methanol, propanol, isopropanol, butanol, sec-butanol, amyl alcohol, hexanol, ethylene glycol, 4-butanediol), diethylene glycol, ethylene glycol monomethyl ether and the like, and any other type of solvent that forms a solution with the heterocyclic N-vinyl monomer and alpha olefins, and is relatively inert toward polymerization and alkylation. Typical free radical chain initiators used for initiating the reaction of monomers are oxygen, hydroperoxides, peroxides and azo compounds. Free radical stabilizing compounds may be combined with the free-radical initiators to control the polymerization process and to produce polymers of a specific composition, while controlling the molecular weight and weight range.

Other embodiments may be prepared by any of the methods known by one with skill in the art and typically by esterification or transesterification between a carboxylic acid, an C₁₋₄ alkyl ester or amide and long chain aliphatic alcohol or mixture thereof. The esterification or transesterification reaction is performed preferably in a liquid aromatic (e.g. toluene) or aliphatic hydrocarbon solvent, in the presence of a catalyst such as p-toluenesulfonic acid, sodium methoxide or ethoxide, etc., and at a temperature ranging from 60 to 200° C. The reaction may be performed with an amount of the long chain alcohol corresponding to the amount needed for the degree of conversion desired

The PPDs according to the present disclosure may be employed alone, or they may be used, in particular embodiments, in combination with one or more additives for improving low temperature flowability and/or other properties, which are in use in the art or known from the literature. Such additives may for example be oxidation inhibitors, corrosion inhibitors, detergents, storage stabilizers, lubricity agents and other pour point depressants.

However, it is within the scope of the present disclosure that the PPDs of the present disclosure may be combined with one or more other PPDs. For example, one skilled in the art would appreciate that use of multiple PPDs may be particularly suitable when treating fluids containing paraffin of wide ranging size (i.e., carbon length). Thus, these other PPDs may be any compounds known by one with skill in the art to exhibit pour point depressant properties. Such PPDs may include oligomers having molecular weights of 1,000 to 10,000, or polymers which have molecular weights greater than 10,000. In some embodiments of the present disclosure, such other PPDs may be ethylene-vinyl acetate (EVA) copolymers, vinyl acetate-olefin copolymers, polyalkyl(meth)acrylates, alkyl esters of styrene-maleic anhydride copolymers, olefin-maleic anhydride copolymers, alkyl esters of unsaturated carboxylic acid-olefin copolymers, alkyl acrylate-alkyl maleate copolymers, alkyl fumarate-vinyl acetate copolymers, alkyl phenols, alpha-olefin copolymers, alkylated polystyrenes, alkylated naphthalenes, ethylene-vinyl fatty acid ester copolymers, or long-chain fatty acid amides.

According to some particular embodiments, the PPDs of the present disclosure may also be combined with one or more acrylate-ester polymers wherein a first portion of the esters along the polymeric backbone includes C₁₂₊ alkyl acrylates and a second portion of the esters includes C₁₋₄ alkyl acrylates. It is within the scope of the present disclosure that these acrylate polymers may be a homopolymer having a portion of the structural units along the formed polymer transesterified by an olefin-containing alcohol or a copolymer formed from two or more alkyl acrylate monomers. In a particular embodiment, the polymers may be a transesterified poly(methyl acrylate) (or transesterified poly(methyl methacrylate)) such that the resulting polymer is a methyl acrylate-alkyl acrylate (or methyl methacrylate-alkyl methacrylate). Further, it is within the scope of the present disclosure that any of the ester groups may be linear or branched.

In particular embodiments of the present disclosure, the alkyl groups of the alkyl-acrylate polymers may comprise at least 12 carbon atoms. The alkyl groups may comprise 12 to 40 carbon atoms in some embodiments of the present disclosure, and 20 to 60 carbon atoms in other embodiments. In other embodiments, the alkyl group of at least one acrylate polymer 18 to 32 carbon atoms. In yet other embodiments, the alkyl group of at least one acrylate polymer may comprise 18 to 28 carbon atoms.

Linear, saturated fatty alcohols of the chain lengths C₈ to C₂₂ may be obtained from natural fats and oils by hydrolysis or methanolysis followed by hydrogenation of the resultant acids or methyl esters. Even longer-chained, linear saturated fatty alcohols C₂₂ to C₄₀ are present in natural waxes, e.g. in beeswax or also in lignite waxes. Petro-chemically linear, saturated fatty alcohols in the chain length range C₆ to C₂₀ may be obtained by the Ziegler process from aluminium, hydrogen and ethylene, while by ethylene polymerization and conversion of the obtained alpha-olefins, alcohols or acids with chain lengths in the range C₂₀ to C₆₀ may be produced.

The final alkyl-acrylate content of these acrylate-ester polymers may range from about 45 to 90% of C₁₂₊ alkyl acrylate, with a balance of 10 to 55% of methyl acrylate (or other C₁₋₄ alkyl acrylate or C₁₋₄ methacrylate) in some embodiments, and from 30 to 70% of C₁₂₊ alkyl acrylate, with a balance of 30 to 70% of methyl acrylate (or other C₁₋₄ alkyl acrylate or C₁₋₄ methacrylate) in other embodiments. Thus, for a polymer produced from a transesterification of poly(methyl acrylate) by a long chain alcohol, the conversion from methyl to long chain alkyl ranges from 30 to 90% of the structural units.

Further, in some embodiments of the present disclosure, these acrylate-ester polymers may have a weight average molecular weight of at least 5000 in some embodiments of the present disclosure, and from 40.000 to 250.000 in others. The acrylate polymers may be prepared by any of the methods known by one with skill in the art and typically by transesterification reaction described above.

Additionally, methyl acrylate-ethoxylated alkyl acrylate polymers or methyl acrylate-hydroxy alkyl acrylate polymers (similar to the acrylate polymers described above) may also be used as additives to further improve the efficiency of the PPDs of the present disclosure.

Generally, each other PPD may be added in a concentration of at least 50 ppm in some embodiments, and in a concentration of from 250 and 5000 ppm in other embodiments.

In yet other embodiments of the present disclosure, the total concentration of PPDs ranges from 250 to 6.000 ppm, or even higher depending on the paraffin content and n-paraffin carbon number distribution of the fluid under investigation. In other embodiments, the PPD may range from 500 to 2.500 ppm.

The PPDs of the present application may be added to the paraffin-containing fluids at a temperature higher than the Wax Appearance Temperature (WAT) of the paraffin-containing fluid, which is defined as the temperature at which the wax starts to precipitate. Indeed, to achieve maximum efficiency, the PPD copolymers and/or polymers should be added before the fluid reaches the WAT so that the PPDs are already dissolved in the fluid when the paraffins start to crystallize.

Further, a particular embodiment of the present disclosures is directed to methods of improving the cold flow properties of a paraffin-containing fluid which comprises admixing with the fluid at least 250 ppm of a copolymer, said copolymer comprising about 20 wt % of vinylpyrrolidone and about 80 wt % of C₃₀ alpha-olefin.

### EXAMPLES

The present disclosure is further exemplified by the examples below which are presented to illustrate certain specific embodiments of the disclosure but are not intended to be construed so as to be restrictive of the spirit and scope thereof.

### Examples 1 and 2

### Two Different Tests were Applied to Study the Efficiency of a Vinyl Pyrrolidone-C₃₀ Alpha-Olefin Copolymer and of Acrylate Polymers as PPDs

A. Pour point measurements were performed to evaluate the lowest temperature at which a movement of the treated oils was observed. The method used to measure the oils' pour points was the manual tilt method. The pour point of a sample of crude oil is the temperature at which the sample ceases to flow. To measure the pour points of synthetic and natural crude oils, a sample (˜42 mL) of the oil under investigation was first heated at a temperature above that of the wax appearance temperature, i.e. 65° C., poured into a glass cylinder, and closed with a tap having a thermometer inserted therein. As the sample cooled, the sample was tested for movement every 3° C. by tilting the cylinder. When movement of the sample stopped completely, 3° C. were added to the measured temperature and this recalculated value was taken as the pour point. The same test was used to quantify the paraffin inhibition activity of the pour point depressants of the present disclosure on the oils under study.
B. Viscosity (η) of the treated oils, measured as a function of the temperature. The viscosity data were measured during a controlled cooling process (2° C./min) by a MCR100 Physica Rheometer (Device: MCR100 SN743426, COM 1=38400, n, 8, 1, x; Measuring system: ST24/PR-A1; TU: TEZ 150P-C).

### Example 3

### Effect of a Vinylpyrrolidone-C₃₀ Alpha-Olefin Copolymer and of Acrylate Polymers on Synthetic Oils

Three synthetic oils (Oil 1, Oil 2 and Oil 3) were used to evaluate the cold flow performance of a vinylpyrrolidone-C₃₀ alpha-olefin copolymer and of acrylate polymers.

Methyl acrylate-alkyl acrylate polymers with long-branched-alkyl side-chains (R) were synthesized by transesterification reaction (Scheme 1 below) between poly(methylacrylate) and C₁₂₋₃₂ branched alcohol (80% of 2-tetradecyloctadecanol). The reaction was carried out with toluene as solvent and NaOCH₃ (0.7 wt %) as the catalyst, under reflux and nitrogen atmosphere for 12 h. Branched C₁₂₋₃₂OH was added to the solution of poly(methylacrylate) in toluene in the amount of 0.40 equivalents. The methanol produced during the reaction was removed as methanol-toluene azeotrope by means of a trap Dean-Stark apparatus.

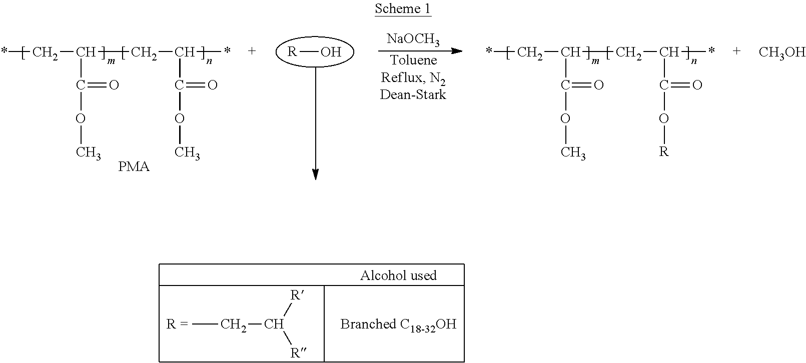

Methyl acrylate-alkyl acrylate polymers with C₁₈₋₃₂ linear-alkyl side-chains (R) were synthesized by transesterification reaction (Scheme 2 below) between poly(methylacrylate) and linear alcohols n-C₁₈₋₃₂OH. The reactions were carried out following a similar procedure to the one describe above, but the C₁₈₋₃₂ linear alcohols were added to the solution of poly(methylacrylate) in toluene in the amount of 0.75 equivalents.

Alcohols such as C₁₈₋₃₂OH, 89% linear C₁₈₋₂₈OH, C₂₀₋₃₂OH and C₂₀₋₃₀OH, with higher percent linearity than 57% linear C₁₈₋₂₈OH, required higher amount of catalyst NaOCH₃ for obtaining higher percent conversion to the acrylate ester polymers. For instance, 11% increase in conversion was observed when the amount of NaOCH₃ was increased from 0.4 to 1.4 wt % (based on the amount of linear alcohol) in the reaction of poly(methylacrylate) with C₁₈₋₃₂OH.

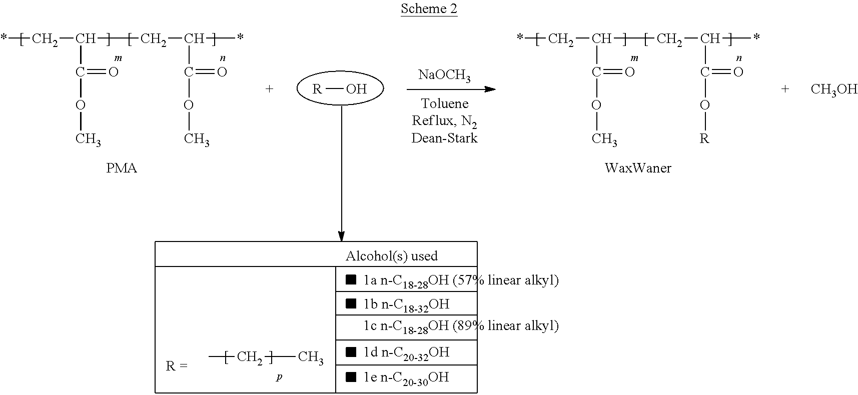

The synthetic oils were made up by mixing independently various synthetic n-paraffins in the appropriate solvent mixture that reproduces crude-oil solvent conditions. Thus, Oil 1 contained 14.4 wt % of wax, a 50:50 mixture of SASOLWAX® 5803 and SASOLWAX® 5805 (i.e. SASOLWAX® 5803-5805) both available from Sasol Wax GmbH (Hamburg, Germany), in decane. Oil 2 contained 14.4 wt % of wax, SASOLWAX® C-80 available from Sasol Wax GmbH (Hamburg, Germany), in decane. Oil 3 was a mixture of 14.4 wt % of SASOLWAX® 5803-5805 and of 14.4 wt % of SASOLWAX® C-80 in decane. The use of other solvents than decane such as kerosene did not influence on the pour point values.

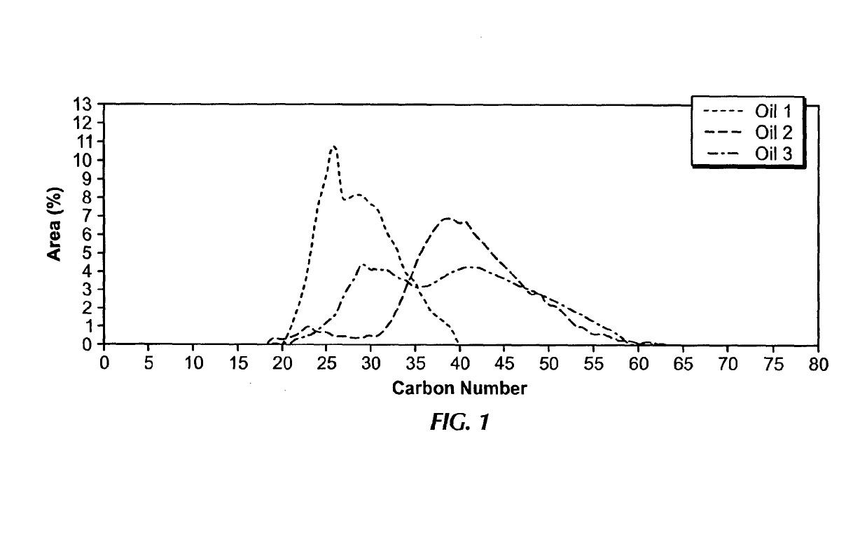

As shown in FIG. 1, Oil 1 mostly contained light-medium molecular weight n-paraffins having a carbon content of from 20 to 40 carbon atoms. Oil 2 mostly contained heavy molecular weight n-paraffins having a carbon content of from 30 to 55 carbon atoms. Oil 3 contained both types of paraffins.

The pour points of Oil 1 and Oil 2 were 33° C. and 57° C. respectively, while Oil 3 had a pour point of 64° C.

A. Pour Point Measurements

The pour point depressants of the present application were used in a concentration of from 250 to 1000 ppm for the three synthetic oils.

The results of the experiments are shown in Table 1 below.

TABLE 1

| Paraffin inhibitor | | | Synthetic oil characteristics | | | | | Treated oil | |
|---|---|---|---|---|---|---|---|---|---|
| | | Addition | | | Paraffin | | Pour | Pour | Pour point |
| | | rate | | Paraffin | content | | point | point | variation |
| Type | | (ppm) | Name | type | (%) | Solvent | (° C.) | (° C.) | (° C.) |
| Vinylpyrrolidone-C₃₀ | | 1000 | Oil 1 | Sasolwax | 14.4 | Decane | 33 | 23 | 10 |
| alpha-olefin | | | | 5803-5805 | | | | | |
| Acrylate | branched | 1000 | | | | | | 33 | 0 |
| polymers | C₁₂₋₃₂ alkyl | | | | | | | | |
| alkyl | 57% linear | 1000 | | | | | | 20 | 13 |
| side-chains | C₁₈₋₂₈ alkyl | | | | | | | | |
| | linear | 1000 | | | | | | 23 | 10 |
| | C₁₈₋₃₂ alkyl | | | | | | | | |
| | 89% linear | 1000 | | | | | | 20 | 14 |
| | C₁₈₋₂₈ alkyl | | | | | | | | |
| | linear | 1000 | | | | | | 26 | 7 |
| | C₂₀₋₃₂ alkyl | | | | | | | | |
| | linear | 1000 | | | | | | 27 | 6 |
| | C₂₀₋₃₀ alkyl | | | | | | | | |
| Vinylpyrrolidone-C₃₀ | | 250-1000 | Oil 2 | Sasolwax | 14.4 | Decane | 57 | <0 | >57 |
| alpha-olefin | | | | C-80 | | | | | |
| Acrylate | branched | 1000 | | | | | | 57 | 0 |
| polymers | C₁₂₋₃₂ alkyl | | | | | | | | |
| alkyl | 57% linear | 1000 | | | | | | 56 | 1 |
| side-chains | C₁₈₋₂₈ alkyl | | | | | | | | |
| | linear | 1000 | | | | | | 42 | 15 |
| | C₁₈₋₃₂ alkyl | | | | | | | | |
| | 89% linear | 1000 | | | | | | 57 | 0 |
| | C₁₈₋₂₈ alkyl | | | | | | | | |
| | linear | 1000 | | | | | | 57 | 0 |
| | C₂₀₋₃₂ alkyl | | | | | | | | |
| | linear | 1000 | | | | | | 35 | 22 |
| | C₂₀₋₃₀ alkyl | | | | | | | | |
| Vinylpyrrolidone-C₃₀ | | 1000 | Oil 3 | Sasolwax | 14.4 + 14.4 | Decane | 64 | 38 | 26 |
| alpha-olefin | | | | 5803-5805 + | | | | | |
| Acrylate | branched | 1000 | | Sasolwax | | | | 64 | 0 |
| polymers | C₁₂₋₃₂ alkyl | | | C-80 | | | | | |
| alkyl | 57% linear | 500 | | | | | | 61 | 3 |
| side-chains | C₁₈₋₂₈ alkyl | | | | | | | | |

From this data, the first observation is that the methyl acrylate-branched C₁₂₋₃₂ alkyl acrylate polymer showed no effect as PPD of any of the synthetic oils under study. Indeed, for each oil, no variation in the pour point was observed. This may be explained by the fact that to obtain a maximum depressant effect, the polymers should present a cloud point close to the oil wax appearance temperature and a melting point close to the paraffins in the oils. This is not the case of the branched acrylate-ester polymer, which has a lower melting point than the paraffin in the synthetic oils, and has also lower cloud and pour point than the wax appearance temperature of Oils 1-3. Therefore it can be concluded that branching in the alkyl side-chains of acrylate-ester polymers will generally show minimum depressant effects.

In the case of the methyl acrylate-linear alkyl C₁₂₊ acrylate polymers, the length of the alkyl side-chains was shown to have a marked influence on the pour point depression. The general tendency (as shown in table 1) was that the polymers with shorter alkyl side-chains, such as methyl acrylate-57% linear C₁₈₋₂₈ alkyl acrylate polymers and methyl acrylate-89% linear C₁₈₋₂₈ alkyl acrylate polymers, where more efficient to treat the lighter C₂₀₋₃₅ n-paraffins contained in Oil 1, while polymers with longer alkyl groups, such as methyl acrylate-linear C₁₈₋₃₂ alkyl acrylate polymers and methyl acrylate-linear C₂₀₋₃₀ alkyl acrylate polymers were more efficient to treat the C₂₅₋₄₀ n-paraffins of Oil 2.

Furthermore, Oil 2 treated with the vinylpyrrolidone-C₃₀ alpha-olefin copolymer experienced very high pour point variations. By contrast, the area of interaction of the copolymer with the n-paraffins of Oil 1 and Oil 3 is smaller, and this is reflected in the lower observed variation in the pour point value.

Thus it is clear that the vinylpyrrolidone-C₃₀ alpha-olefin copolymer reduced wax deposition in Oil 1, Oil 2 and Oil 3. However, this copolymer was more efficient over high molecular weight C₃₀₋₅₅ n-paraffins (Oil 2). Thus, copolymers having long alkyl side-chains may be the most effective in decreasing the pour point of oils with higher molecular weight paraffins such that contained in Oil 2. This is the case of the vinylpyrrolidone-C₃₀ alpha-olefin copolymer and its 1-tricosene (C₃₀ alpha-olefin) moiety.

Oil 3 contained both light-medium and heavy molecular weight paraffins, and the resulting variations of pour point was not as significant as that observed for Oils 1 and 2. The explanation of this result is hypothesized to be that the vinylpyrrolidone-C₃₀ alpha-olefin copolymer or methyl acrylate—57% linear C₁₈₋₂₈ alkyl acrylate polymer mainly interacts with the heavier molecular weight paraffins and not with the lighter molecular weight paraffins.

To verify this hypothesis, the synergistic/antagonist effects of combining various (co)polymers on the cold flow performance were investigated. Because Oil 3 (with 28.8 wt. % wax content) was a combination of the synthetic waxes contained in Oil 1 and Oil 2, i.e. it contained both lighter and heavier molecular weight paraffins, a mixture of vinylpyrrolidone-C₃₀ alpha-olefin copolymer and of 57% linear C₁₈₋₂₈ acrylate-ester polymer (high molecular weight (co)polymer) was tried to treat Oil 3.

The vinylpyrrolidone-C₃₀ alpha-olefin copolymer and the 57% linear C₁₈₋₂₈ acrylate-ester polymer were added together to Oil 3 in concentrations of 1000 ppm and 500 ppm respectively.

The results of the experiments are shown in Table 2 below.

TABLE 2

| Synthetic oil characteristics | | | | | Paraffin | Treated oil | |
|---|---|---|---|---|---|---|---|
| | | Paraffin | | Pour | inhibitor | Pour | Pour point |
| | | content | | point | Addition rate | point | variation |
| Name | Paraffin type | (%) | Solvent | (° C.) | (ppm) | (° C.) | (° C.) |
| Oil 3 | SASOLWAX ® | 14.4 + 14.4 | Decane | 64 | 500 of methyl | 15 | 49 |
| | 5803-5805 + | | | | acrylate-57% | | |
| | SASOLWAX ® | | | | linear C₁₈₋₂₈ alkyl | | |
| | C-80 | | | | acrylate-ester + | | |
| | | | | | 1000 of VP-C₃₀ | | |
| | | | | | alpha-olefin | | |

Synergistic effects of both PPDs were observed on the pour point depression of Oil 3. The pour point of Oil 3 decreased from 64° C. to 15° C., which was a larger variation than that observed when treating Oil 3 with only a vinylpyrrolidone-C₃₀ alpha-olefin copolymer or a methyl acrylate—57% linear C₁₈₋₂₈ alkyl acrylate polymer. Thus, it may be concluded that a high-molecular weight polymer such as a methyl acrylate—57% linear C₁₈₋₂₈ alkyl acrylate polymer seemed to prevent the deposition mainly of the lighter molecular weight n-paraffins (SASOLWAX® 5803-5805). Lower molecular-weight polymers like vinylpyrrolidone-C₃₀ alpha-olefin copolymer appeared to have enough molecular volume to prevent the deposition of the high molecular weight n-paraffins (SASOLWAX® C-80).

B. Viscosity Measurements

The evolution of the viscosity of Oils 1 and 2, each containing 1000 ppm of vinylpyrrolidone-C₃₀ alpha-olefin copolymer or of methyl acrylate-linear C₁₂₊ alkyl acrylate polymer, was investigated.

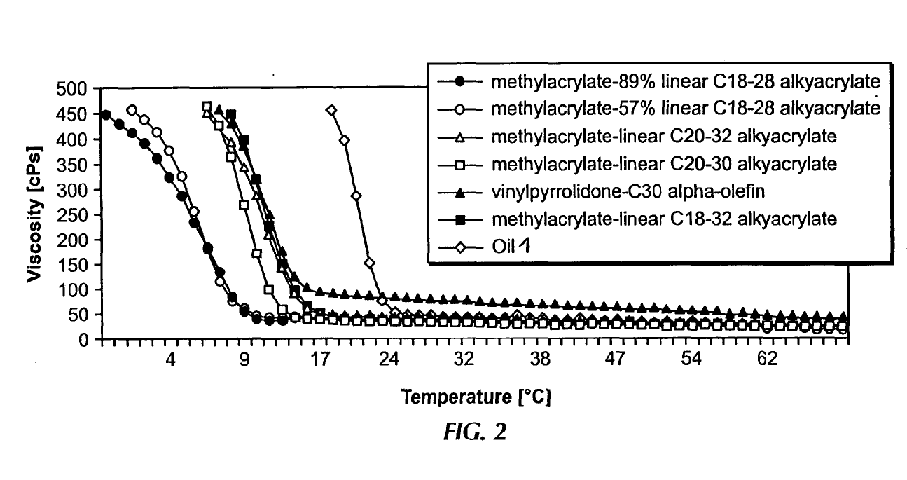

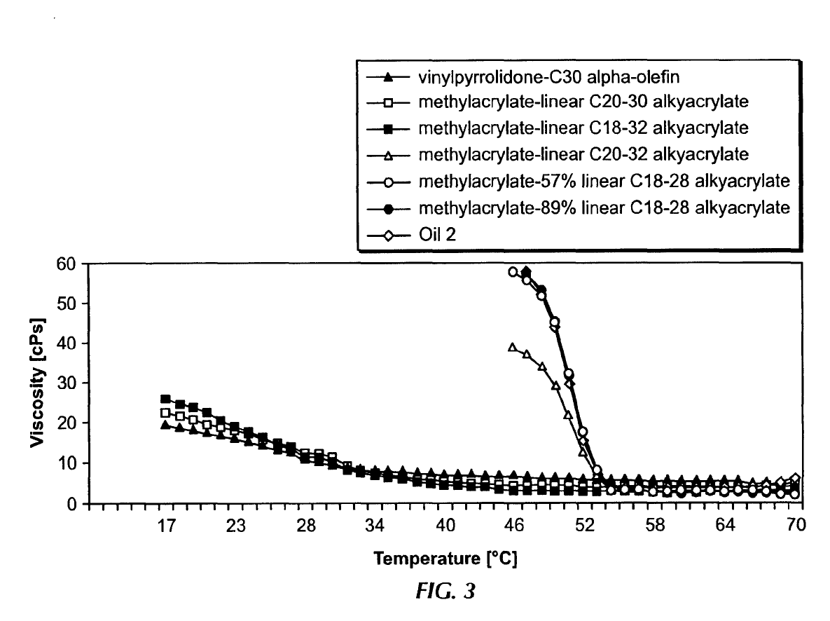

FIGS. 2 and 3 show the viscosity behavior of the treated Oils 1 and 2 as a function of the temperature. Based on these viscosity-temperature plots, the viscosities of Oils 1 and 2 were also influenced significantly by the length of the alkyl side-chains (R) in the (co)polymers under study. Viscosity variations followed similar patterns to those observed for the pour point measurements. Thus, the polymers with shorter alkyl side-chains (methyl acrylate—57% linear C₁₈₋₂₈ alkyl acrylate polymers and methyl acrylate-89% linear C₁₈₋₂₈ alkyl acrylate polymers, were more efficient to treat the C₂₀₋₃₅ n-paraffins contained in Oil 1, and consequently reduce its viscosity (See FIG. 2). On the contrary, polymers with longer pendent groups, such as methyl acrylate-linear C₂₀₋₃₀ alkyl acrylate polymers and vinylpyrrolidone-C₃₀ alpha-olefin copolymer, were more efficient to decrease the viscosity of Oil 2 (See FIG. 3).

### Example 4

### Effect of a Vinylpyrrolidone-C₃₀ Alpha-Olefin Copolymer and of Acrylate Polymers on Various Natural Crude Oils

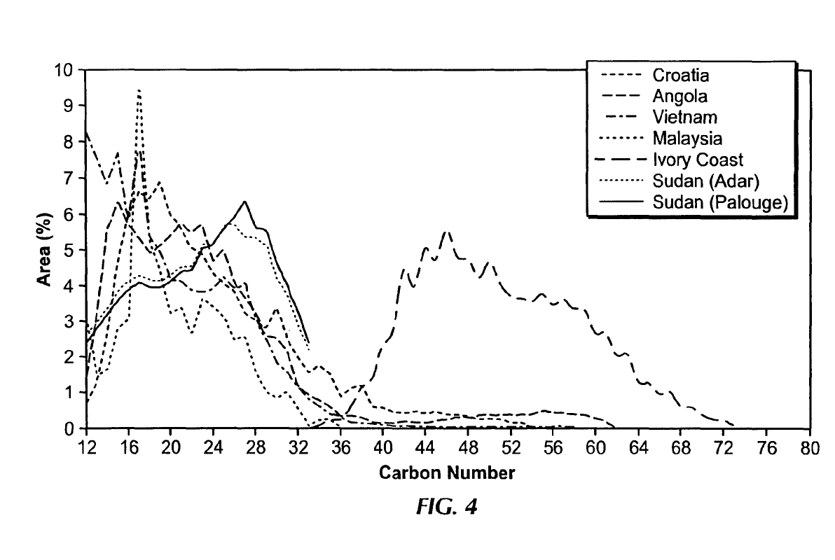

The target natural crude oils are oils from fields in Sudan (Palouge), Sudan (Adar), Vietnam, Croatia, Angola, Ivory Coast and Malaysia. As illustrated in FIG. 4, these crude oils contain a significant amount of high molecular weight n-paraffins with a carbon content of more than 25 carbon atoms which is reflected in their high pour point values of 21-73° C.

A. Pour Point Measurements

The crude oil samples were treated with 1000-2500 ppm of the vinylpyrrolidone-C₃₀ alpha-olefin copolymer or acrylate polymers according to the present application.

The results of the experiments are shown in Table 3 below.

TABLE 3

| | | | Crude oil | | | | |
|---|---|---|---|---|---|---|---|
| Paraffin inhibitor | | | characteristics | | | Treated oil | |
| | | Addition | | | Pour | | Pour point |
| | | rate | | WAT | point | Pour | variation |
| Type | | (ppm) | Name | (° C.) | (° C.) | point (° C.) | (° C.) |
| Acrylate | branched | 2500 | Sudan | 86 | 42 | 42 | 0 |
| polymers | C₁₂₋₃₂ alkyl | | (Palouge) | | | | |
| alkyl | 57% linear | 2500 | | | | 39 | 3 |
| side-chains | C₁₈₋₂₈ alkyl | | | | | | |
| Acrylate | branched | 1000 | Sudan | 68 | 39 | 39 | 0 |
| polymers | C₁₂₋₃₂ alkyl | | (Adar) | | | | |
| alkyl | 57% linear | 1000 | | | | 39 | 0 |
| side-chains | C₁₈₋₂₈ alkyl | | | | | | |
| Acrylate | branched | 1000 | Vietnam | 66 | 36 | 36 | 0 |
| polymers | C₁₂₋₃₂ alkyl | | | | | | |
| alkyl | 57% linear | 1000 | | | | 36 | 0 |
| side-chains | C₁₈₋₂₈ alkyl | | | | | | |
| Vinylpyrrolidone-C₃₀ | | 1000 | Croatia | — | 33 | 13 | 20 |
| alpha-olefin | | | | | | | |
| Acrylate | branched | 1000 | | | | 33 | 0 |
| polymers | C₁₂₋₃₂ alkyl | | | | | | |
| alkyl | 57% linear | 1000 | | | | 20 | 13 |
| side-chains | C₁₈₋₂₈ alkyl | | | | | | |
| | linear | 1000 | | | | 27 | 6 |
| | C₁₈₋₃₂ alkyl | | | | | | |
| | 89% linear | 1000 | | | | 21 | 12 |
| | C₁₈₋₂₈ alkyl | | | | | | |
| | linear | 1000 | | | | 22 | 11 |
| | C₂₀₋₃₂ alkyl | | | | | | |
| | linear | 1000 | | | | 25 | 8 |
| | C₂₀₋₃₀ alkyl | | | | | | |
| Vinylpyrrolidone-C₃₀ | | 1000 | Ivory | — | 73 | 66 | 7 |
| alpha-olefin | | | Coast | | | | |
| Acrylate | branched | 1000 | | | | 73 | 0 |
| polymers | C₁₂₋₃₂ alkyl | | | | | | |
| alkyl | 57% linear | 1000 | | | | 73 | 0 |
| side-chains | C₁₈₋₂₈ alkyl | | | | | | |
| Vinylpyrrolidone-C₃₀ | | 1000 | Angola | — | 32 | 25 | 7 |
| alpha-olefin | | | | | | | |
| Acrylate | branched | 1000 | | | | 32 | 0 |
| polymers | C₁₂₋₃₂ alkyl | | | | | | |
| alkyl | 57% linear | 1000 | | | | 4 | 28 |
| side-chains | C₁₈₋₂₈ alkyl | | | | | | |
| Acrylate | branched | 1000 | Malaysia | 24 | 21 | 21 | 0 |
| polymers | C₁₂₋₃₂ alkyl | | | | | | |
| alkyl | 57% linear | 1000 | | | | 9 | 12 |
| side-chains | C₁₈₋₂₈ alkyl | | | | | | |

None of the crudes experienced any pour point variation when they were treated with the methyl acrylate-branched C₁₂₋₃₂ alkyl acrylate polymer, as previously observed for synthetic oils in Table 1.

Almost no variation in the pour point was observed when the methyl acrylate-57% linear C₁₈₋₂₈ alkyl acrylate polymer was used in the treatment of Sudan-Palouge, Sudan-Adar and Vietnam crude oils, even at concentrations as high as 2500 ppm. The results may be explained by the high proportion (26-44%) of C₂₅₊ n-paraffins present in these crude oils.

Croatia and Ivory Coast crude oils possess an important amount, 22% and 59% respectively, of high molecular weight n-paraffins with carbon numbers between C₃₀ and C₅₅. Therefore, a PPD with long-alkyl side-chains such as vinylpyrrolidone-C₃₀ alpha-olefin copolymer or methyl acrylate—57% linear C₁₈₋₂₈ alkyl acrylate polymer should be more efficient in inhibiting wax deposition and this is reflected in the pour point variation values obtained, particularly for Croatia. However no variation or very little was observed for the treated Ivory Coast crude oil. This might be explained by the possibility that the area of interaction of the vinylpyrrolidone-C₃₀ alpha-olefin copolymer or the methyl acrylate-57% linear C₁₈₋₂₈ alkyl acrylate polymer with the n-paraffins in the crude does not include C₅₀₊ linear paraffins.

In the case of Angola and Malaysia crude oils, the methyl acrylate—57% linear C₁₈₋₂₈ alkyl acrylate polymer exhibited a high efficiency in inhibiting paraffin deposition. In the case of Angola crude oil, the vinylpyrrolidone-C₃₀ alpha-olefin copolymer did not exhibit a high efficiency in inhibiting paraffin deposition. In particular, when 1000 ppm of the copolymer were added to the Angola crude oil, the pour point decreased from 32° C. to 25° C. By contrast, when 1000 ppm of the methyl acrylate-57% linear C₁₈₋₂₈ alkyl acrylate polymer were used to treat the Angola oil, an important variation in the pour point from 32° C. to 4° C. was observed. So (co)polymers with shorter alkyl side-chains (C₁₈₋₂₈) than the vinylpyrrolidone-C₃₀ alpha-olefin copolymer were the most effective in decreasing the pour point of oils with lighter n-paraffins such as Angola crude oil. A lower, but still important variation of 12° C. in the pour point was observed when the Malaysia oil was treated with 1000 ppm of the methyl acrylate—57% linear C₁₈₋₂₈ alkyl acrylate polymer.

B. Viscosity Measurements

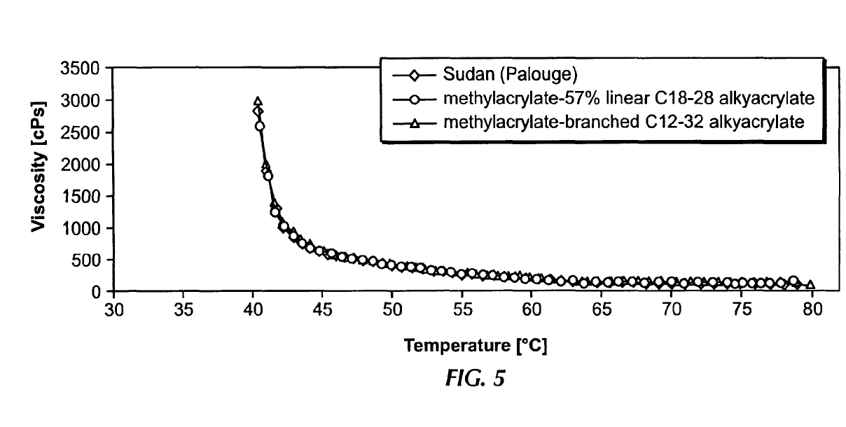

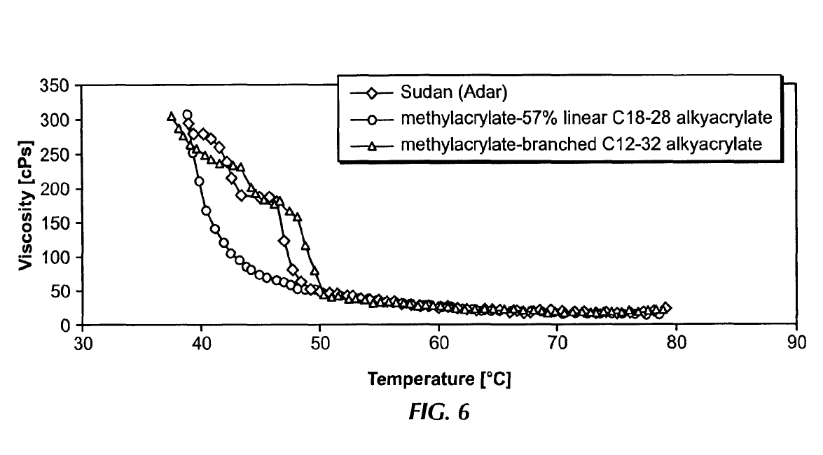

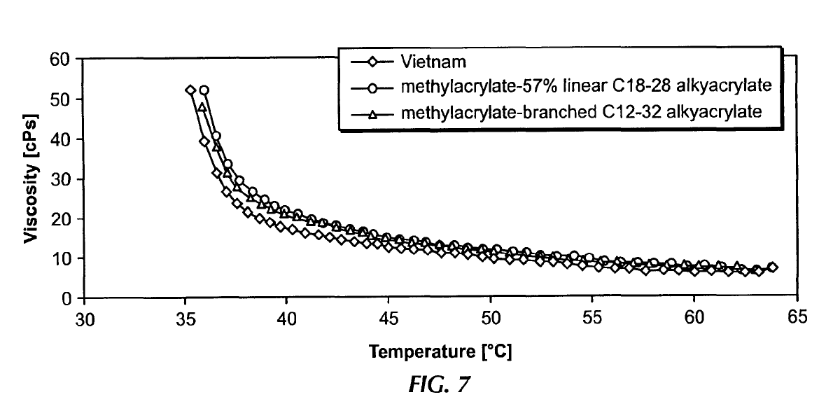

The viscosities of Sudan-Palouge (See FIG. 5), Sudan-Adar (See FIG. 6) and Vietnam (See FIG. 7) crude oils treated with the methyl acrylate-branched C₁₂₋₃₂ alkyl acrylate polymer or the methyl acrylate—57% linear C₁₈₋₂₈ alkyl acrylate polymer were measured as a function of the temperature. The viscosity of Sudan-Adar experienced some variation only when the crude oil was treated with 1000 ppm of the methyl acrylate—57% linear C₁₈₋₂₈ alkyl acrylate polymer. The methyl acrylate-branched C₁₂₋₃₂ alkyl acrylate polymer showed no improvement on the viscosity, and neither on the pour point depression of any of these crudes, as previously stated.

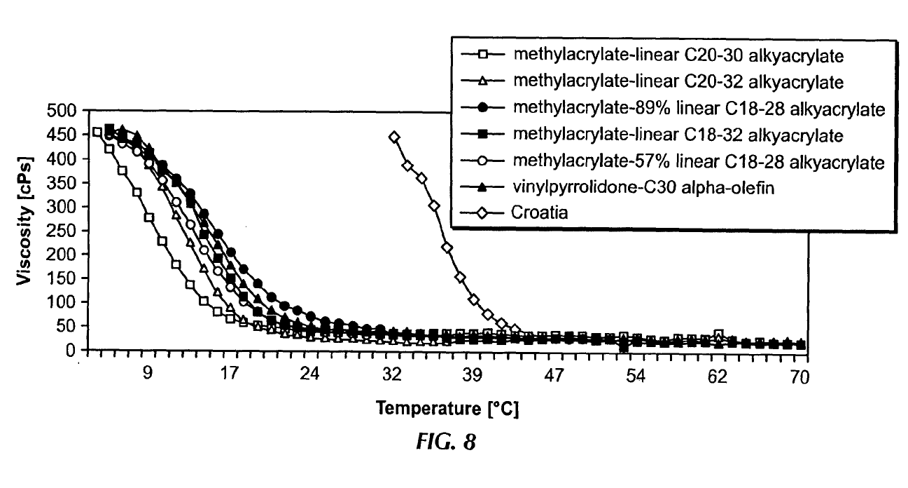

When Croatia crude oil (See FIG. 8) was treated with the vinylpyrrolidone-C₃₀ alpha-olefin copolymer, 57% linear C₁₈₋₃₂ alkyl acrylate polymers, the methyl acrylate linear C₂₀₋₃₂ alkyl acrylate polymer and the methyl acrylate-linear C₂₀₋₃₀ alkyl acrylate polymer were the ones which showed the highest viscosity variations, most probably due to a better match between the pendent chains of these (co)polymers and the n-paraffin distribution of the Croatia oil.

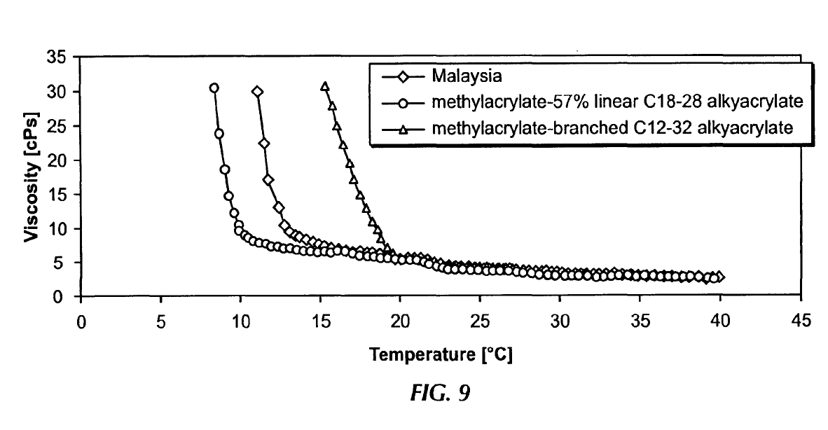

In the case of Malaysia (See FIG. 9), the methyl acrylate—57% linear C₁₈₋₂₈ alkyl acrylate polymer was the most efficient in reducing viscosity as well as pour point.

To summarize, the efficiency of the vinylpyrrolidone-C₃₀ alpha-olefin copolymer and of the methyl acrylate—57% linear C₁₈₋₂₈ alkyl acrylate polymer as PPD of natural crude oils containing C₂₅₊ n-paraffins was clearly demonstrated. However, good results obtained on synthetic crude oils could not always be translated to natural crude oils. Other unknown factors such as the presence of asphaltenes, branched paraffins, isoparaffins and aromatic compounds (cycloparaffins, naphthalenes) in these crude oils might explain the different results obtained after the treatments.

Advantageously, embodiments of the present disclosure may provide for at least one of the following. Methods of the present disclosure allow for efficient treatment of fluids containing significant amounts of heavy linear paraffins with more than 25 carbon atoms such that wax deposition is inhibited. Thus, use of the PPDs of the present disclosure may provide cost effective performance in a wide range of crude oils and applications. Because the tendency towards wax crystallization increases with the content of large linear alkanes (≧C₁₈H₃₄) in paraffin-containing fluids, the development of the pour point depressants of the present disclosure may broaden the range of carbon chain lengths for which a pour point depressant is effective, thus counteracting the problems caused by paraffin waxes, an issue of significant importance for the oil industry. Further, because production of crude oils with high proportions of C₂₅₊ paraffins is increasing due to high oil prices, which induce the exploitation of marginal reserves and to advancements in production technology, which enable the production of heavy crudes and turn the dwindling reserves into viable production sources, the pour point depressants of the present disclosure may have even greater applicability.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

1. A method of improving the cold flow properties of a paraffin-containing fluid comprising:
admixing an effective amount of a polymer comprising cyclic amide and long chain alkyl functionality.

2. The method of claim 1, wherein at least one of a vinyl pyrrolidone and vinyl caprolactam monomer form the cyclic amide functionality.

3. The method of claim 1, wherein an alpha-olefin monomer forms the long chain alkyl functionality.

4. The method of claim 1, wherein an esterified ester or amide forms the long chain alkyl functionality.

5. The method of claim 1, wherein the polymer is a copolymer of a lactam and an alpha-olefin.

6. The method of claim 1, wherein the polymer is a copolymer of a lactam and acrylate, wherein the acrylate is transesterfied after the copolymerization.

7. The method of claim 1, wherein the fluid contains high molecular weight linear paraffins with at least 20 carbon atoms.

8. The method of claim 2, wherein the fluid contains high molecular weight linear paraffins with at least 25 carbon atoms.

9. The method of claim 5, wherein at least one copolymer comprises from 20 to 50 wt % of vinylpyrrolidone and 50 to 80 wt % of alpha-olefin.

10. The method of claim 3, wherein the alpha-olefin of at least one copolymer comprises at least 12 carbon atoms.

11. The method of claim 10, wherein the alpha-olefin of at least one copolymer comprises 16 to 30 carbon atoms.

12. The method of claim 1, wherein the polymers are used in combination with one or more other pour point depressants comprising at least one of ethylene-vinyl acetate (EVA) copolymers, vinyl acetate-olefin copolymers, polyalkyl(meth)acrylates, alkyl esters of styrene-maleic anhydride copolymers, olefin-maleic anhydride copolymers, alkyl esters of unsaturated carboxylic acid-olefin copolymers, alkyl acrylate-alkyl maleate copolymers, alkyl fumarate-vinyl acetate copolymers, alkyl phenols, alpha-olefin copolymers, alkylated polystyrenes, alkylated naphthalenes, ethylene-vinyl fatty acid ester copolymers, or long-chain fatty acid amides.

13. The method of claim 1, wherein the polymers are used in combination with one or more acrylate-ester polymers.

14. The method of claim 13, wherein at least one of the acrylate-ester polymers is a C₁₋₄ alkyl acrylate-linear C₁₂₊ alkyl acrylate polymer.

15. The method of claim 14, wherein at least one of the acrylate-ester polymers is a C₁₋₄ alkyl acrylate-linear C₁₈₋₃₂ alkyl acrylate polymer.

16. The method of claim 15, wherein at least one of the acrylate-ester polymers is a C₁₋₄ alkyl acrylate-linear C₁₈₋₂₈ alkyl acrylate polymer.

17. The method of claim 1, wherein the admixing occurs at a temperature higher than the wax appearance temperature of the paraffin-containing fluid.

18. A method of improving the cold flow properties of a paraffin-containing fluid comprising:
admixing with the fluid a copolymer formed from vinylpyrrolidone and a C₁₂₊ alpha-olefin.

19. The method of claim 18 wherein the copolymer is used in combination with methyl acrylate-linear C₁₈₋₂₈ alkyl acrylate polymer.
